(19) United States
(12) Patent Application Publication
(10) Pub. No.: US 2005/0286604 A1
(43) Pub. Date: Dec. 29, 2005

(54) Electrode system for glass melting furnaces

(76) Inventor: Lothar Rott, Lohr am Main (DE)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/155,244

(22) Filed: Jun. 17, 2005

(30) Foreign Application Priority Data
Jun. 29, 2004 (DE) P1004031241.9-45

(51) Int. Cl. H05B 7/06

(52) U.S. Cl. 373/93

(57) ABSTRACT

An electrode system for glass melting furnaces with a melting tank is provided with an electrode holder (9) installed above the melt surface (20) and this electrode holder (9) has a coolant supply (24) and a metallic electrode (7). This is connected to the electrode holder (9) by means of a coolable threaded connection (8), whereby the coolant supply (24) projects into the upper end of the electrode (7). In order to install the cooled threaded connection (8) in the furnace chamber and to fit a permanent sheath (31) made of mineral material round the upper, cooled end of the electrode (7) and to protect this sheath (31) not only against chemical attack, but against mechanical cracking-off, in accordance with the invention the coolable end of the electrode (7) is surrounded by the sheath (31) of ceramic material, that is at least partly installed in a protective casing (32) made from corrosion and heat resistant metal. The ceramic sheath (31) is preferably connected to the electrode (7) by means of a contact cement (33).

### BACKGROUND OF THE INVENTION

The invention relates to an electrode system for glass melting furnaces with a melting tank and an electrode holder installed above the melt surface with a coolant supply and a metallic electrode, which is connected to the electrode holder by a coolable screw connection, whereby the coolant supply reaches into the top end of the electrode.

It is known that glass melts in furnaces can be heated by means of electrodes that are introduced into the melt through the bottom or the side walls of the melting tank or from above through the furnace crown, and these can be advanced as necessary to compensate for the unavoidable corrosion. There is no known material that can permanently withstand the glass melt.

As it is necessary to exchange electrodes their installation through the bottom and/or the side walls of the melting tank is complicated in terms of both design and operation, as the openings that are made must be closed off in order to prevent the glass from draining out. Therefore there is now a tendency to install electrodes from above. These are also described as immersion or top electrodes.

Normally the electrodes and their holders—whether cooled or not—are connected to one another by means of electrically conducting threads, which must remain easily releaseable for the exchange or advancing of the electrodes. This poses a number of diametrically opposed problems. With non-cooled electrode connections the threads are normally outside the furnace chamber, which requires a much longer electrode or electrode segment.

A further problem is that the materials used are susceptible to corrosion, in particular in the area of very aggressive batch and glass gall, that float on the glass melt as a result of the melting process. Up to the three phase boundary at the glass melt surface there is also the oxidizing effect of the oxygen contained in air, whereby it should be noted that molybdenum or tungsten for instance oxidize rapidly above about 550° C. to 600° C.

European patent 0 465 688 B1 discloses that in the case of electrodes immersed in a glass melt from above, a corrosion resistant connector made of chrome or an oxide-dispersed material is installed between an electrode holder and a rod-shaped electrode made of molybdenum, platinum, tungsten or their alloys, that has the same diameter as the electrode and which contains a concentric double-walled cooling channel for the water-cooling. During operation the connector, which is designed for permanent use and must have two threads, is installed at a height at which a corrosive gall layer floats on the glass melt. As a result some of the heat is removed from the glass at a location which has just been heated up by an electrode that must be exchanged from time to time owing to corrosion.

In DE 101 32 729 B4 and DE 201 21 350 U1 the advantages and disadvantages of air and water cooling of an electode holder for a top electrode are compared with one another and finally water cooling is abandoned for several reasons. Here the connection, e.g. a threaded connection, between the electrode and its holder lies above a cover block that is lined with a refractory sleeve for the passage of the electrode. The connection between the non-cooled electrode and the electrode holder, that is fitted with cooling ribs for air cooling, is located inside insulation bricks that are placed on the furnace crown. The melt surface is hereby inside the said refractory sleeve, whereby it is not clear how the melt surface can run inside the cover block, as no free space is available. The electrode is surrounded by a protective sheath which extends below the melt surface. This protective sheath is attached to the electrode holder by a gas-tight weld, whereas an air gap to the electrode is left free. This protective sheath that, for instance, should be made of refractory material, is surrounded by a precious metal casing.

As neither the electrode nor the precious metal casing are permanently resistant to corrosion, glass melt and any batch and/or glass gall that float on the glass melt can enter the said air gap, which is an annular gap. If such an electrode system is removed from the furnace crown in order to change an electrode, the material that has entered the annular gap freezes quickly, which makes it more difficult to change the electrode, especially as the protective sheath is welded to the electrode holder. No solution for this problem is indicated.

The problem occurs when the threaded connection is located in the furnace chamber and is equipped with a cooling system that normally consists of a concentric water pipe, over the external surface of which the cooling water returns. The forced cooling results in considerable temperature differences that cause the ceramic sheath or the protective coating to crack off.

DE 100 05 821 A1 discloses a cooled precious metal electrode, that is preferably installed in the bottom of a melting tank, where there is the risk of glass leakage if an electrode breaks. This hazard only occurs in the case of side wall and bottom electrodes. It is stated that the electrode is introduced through a hole in the refractory material. This statement also implies that a bottom electrode is meant. There is no information about any installation from above, nor are the method and manner of such installation explained, or how the coolant supply and return flow are effected. That the centre of the electrode can be screwed to a holder, but the precious metal outer skin of the electrode is welded to the holder is disclosed as state-of-the-art. This would render it impossible to exchange the electrode by separating it from the holder. In particular, there is no mention of the corrosive influence of the three phase boundary of glass, glass gall and the oxidizing gaseous atmosphere at the top end of the electrode. Nor is it mentioned that electrodes are not permantently corrosion resistant and wear away. A coolant passage that extends along the complete electrode length would become open if the outer skin were to wear away, and the coolant would come into contact with the hot glass melt, which can result in steam explosions.

The typical melting behaviour of electrode segments is disclosed in FIG. 6 of the similar EP 0 372 111 B1 (=U.S. Pat. No. 4,965,812). In the main such electrodes are made of solid metal and have a significantly higher thermal efficiency, because less heat is removed from the non-cooled section. Here it should be noted that such electrodes are installed in the same glass melt on a number of occasions. Here corrosion and thermal efficiency are diametrically opposed to one another. FIG. 6 shows the wear pattern of sections of electrodes that have been advanced. The lower threaded connections are no longer cooled, because the cooling channel is interrupted at this location. Furthermore, it is stated that in the ideal case the electrodes are completely used up and no electrode material remains. Such melting behaviour is unthinkable with the object of DE 100 05 821 A1, as the cooling system would be opened up.

The only common aspect of the objects of the two publications DE 100 05 821 A1 and EP 0 372 111 B1 lies in the fact that no additional protection against wear caused by corrosion and oxidation at the upper end of the electrode is disclosed.

The object of the present invention is therefore to provide an electrode system of the type specified above, in which the cooled threaded connection is located inside the furnace chamber and the upper, cooled end of the electrode is surrounded by a casing made of mineral material, and whereby this casing is protected not only against excessive chemical wear but also against cracking-off caused by differences and changes in temperature.

### SUMMARY OF THE INVENTION

The object is accomplished in accordance with the invention by an electrode system as specified above, in which the coolable end of the electrode is surrounded by a sheath made of ceramic material, that is at least partly installed in a protective casing made of a corrosion and temperature resistant metal.

The object is therefore completely accomplished, i.e. this sheath is not only protected against excessive chemical corrosion, but also against mechanical cracking-off caused by temperature differences and temperature changes.

It is of particular importance that the electrode holder is located above the melt surface, that it reaches into the top end of the electrode, and that it is the coolable end of the electrode that is surrounded by a sheath made of ceramic material, which itself is installed in a protective casing made of corrosion and temperature resistant metal. As the coolant is supplied solely to the upper end of the electrode the coolant passage does not open up when the larger remaining end of the electrode becomes worn, which can lead to a steam explosion. Furthermore the thermal efficiency is increased as the heat transfer is reduced in comparison with complete cooling over the total length of the electrode.

With regard to further embodiments of the invention it is particularly advantageous, if—either individually or in combination:
the ceramic sheath is connected to the electrode by means of a contact cement,
the ceramic sheath is made of a fusion-cast material from the group of aluminium-zircon-silicates,
the ceramic sheath is designed as a hollow cylinder and has a wall thickness between 10 and 30 mm and is 80 to 150 mm long,
the contact cement comprises material from the zircon mullite group,
the contact cement has a thickness between 0.5 and 2 mm,
the protective casing is made from a material from the group of iron-chromium alloys,
the protective casing is made from a stainless steel, e.g. type PM 1000,
the protective casing has a wall thickness between 0.25 and 1 mm,
the protective casing covers at least the outer circumference area of the ceramic sheath, and/or, if
the protective casing and the top end of the ceramic sheath are covered with cement, that is attached to the electrode holder.

Further details and advantages are referred to in the detail description.

### BRIEF DESCRIPTION OF THE DRAWINGS

An example of the object according to the invention and its effect and advantages are explained in more detail in FIGS. 1 and 2 as follows:

FIG. 1 shows a partial vertical section through a glass melting furnace and a side view of the electrode swivel system and

FIG. 2 shows a partial vertical section through the threaded connection of the electrode holder and the electrode.

### DETAILED DESCRIPTION OF THE PREFERRED EMBODIMENTS

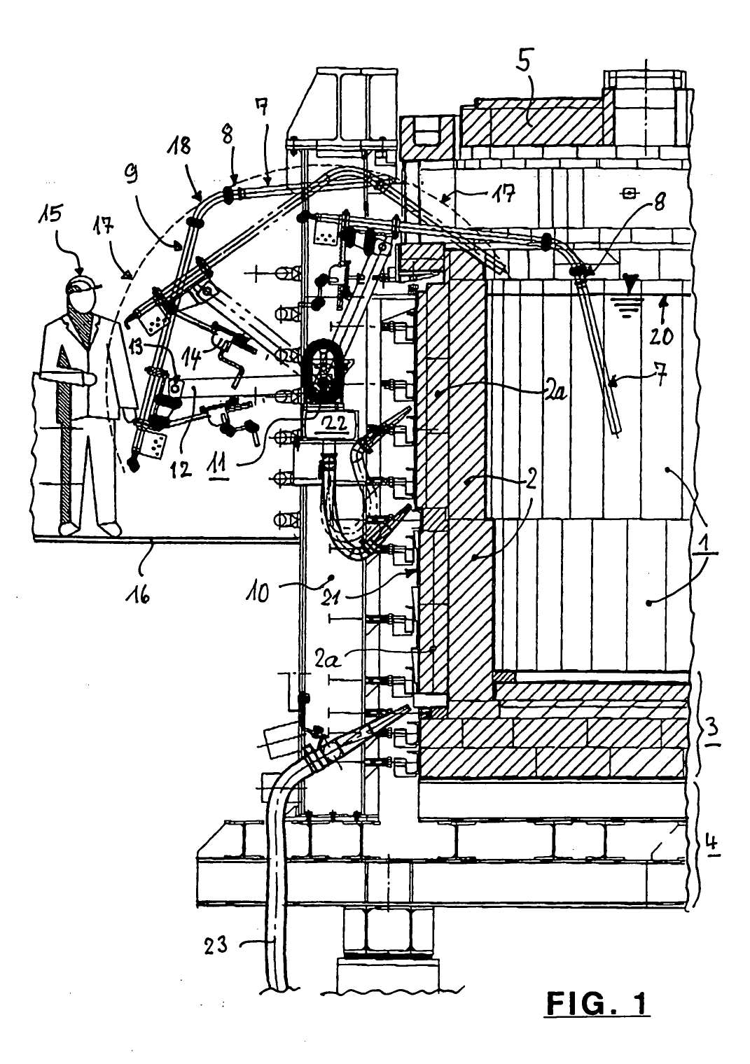

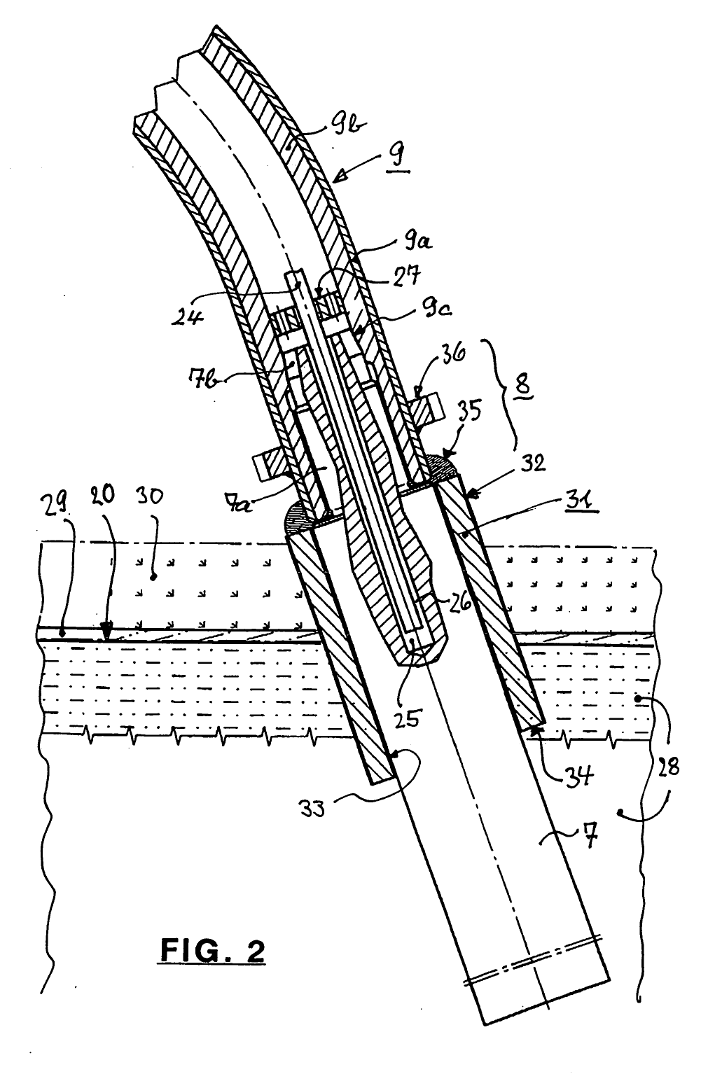

FIG. 1 shows a relevant section from a melting tank 1 with a vertical tank wall 2 and an horizontal tank bottom 3, that rests on supporting steelwork 4 made of double T girders. The furnace is surmounted by a furnace crown 5. Between the latter and the furnace wall 2 there is at least one aperture 6 for insertion and retraction of an individual electrode 7, that is attached by means of a threaded connection 8 to an electrode holder 9. Details of this threaded connection 8 are shown in FIG. 2.

Outside the furnace 1 there is a vertical support pillar 10 that is mounted on the supporting steelwork 4. This pillar 10 supports a swivel joint 11, around which the swivel lever 12 with a further joint 13 can be swivelled. The relative angular position and so the immersion depth of the electrode 7 can be adjusted by the jacking mechanism 14. The swivel movement is carried out by an operator 15, who stands on a working platform 16. The swivel radius 17 of the outermost point of an elbow 18 within the electrode holder 9 is indicated by a dotted arc, the height of the melt surface 20 by a straight line.

The tank wall 2 with its thermal insulation 2a is covered externally by a metal casing 21, towards which several cooling nozzles, that are not detailed here, are directed. These cooling nozzles are connected to the supply lines 22 and 23. It can be seen that the electrode 7 can be exchanged when the electrode holder 9 has been completely swivelled out.

FIG. 2 shows the furnace-interior end of the electrode holder 9, that has an outer tube 9a made of material, such as stainless steel, that is resistant to heat, chemical and mechanical influences and an inner tube 9b that is made of material that provides good electrical conductivity, such as copper. The inner tube 9b is provided with a female thread and a conical surface 9c at its lower end.

Inside the electrode holder 9 is the coolant supply 24, which is in the form of a pipe, the end of which extends noticeably past the end of the electrode holder 9 and projects into a cavity 25 of the electrode 7. A coolant such as water is supplied through this tube into the upper end of the electrode 7 and returned to the electrode holder 9 via an annular gap 26.

The upper end of the electrode 7 has a thread 7a with a reduced diameter and a conical end 7b that is designed to fit the conical surface 9c of the inner tube so as to provide a good electrical contact when screwed together. The coolant supply 24 is fixed in a perforated plate 27 in the centre of the electrode holder 9.

The contents of the melting furnace 1 shown in FIG. 1 is comprised of the glass melt 28, upon which float first a gall layer 29 and then on this a batch layer 30 comprising the glass raw materials, which may include glass cullet from recycled material.

In the vicinity of the glass surface, the gall layer 29 and the batch layer 30, the electrode 7 is inserted into a hollow cylindrical sheath 31, made from a ceramic material that is encased in a thin-walled protective casing 32 made from corrosion and heat resistant material such as stainless steel. The sheath 31 is itself attached to the electrode 7 by means of a layer of contact cement 33. It is not necessary to cover the lower ring-shaped front end 34 of the sheath 31 with a metal ring. However the upper end should be sealed to the electrode holder 9 by a fillet of cement 35, because at this location a disc shaped gap is left in order to avoid a mechanical misalignment of the cylindrical contact areas (7b/9c) and this must be closed off. A ring 36 with a multi-facetted edge is fitted to the lower end of the electrode holder 9 as a gripping point for a spanner.

It is therefore obvious that the internal cooling permits the threaded connection 8 to be easily unscrewed even after long operation, and the sheath 31, covered by the protective casing 32, is protected from cracking-off caused by the steep temperature gradients and erosion by the surrounding aggressive materials.

From the above description, it is apparent that the objects of the present invention have been achieved. While only certain embodiments have been set forth, alternative embodiments and various modifications will be apparent from the above description to those skilled in the art. These and other alternatives are considered equivalents and within the spirit of the scope of the present invention. It should be understood that I wish to embody within the scope of the patent warranted hereon all such modifications as reasonably and properly come within the scope of my contribution to the art.

### REFERENCE NUMBERS

1 Furnace
2 Furnace wall
2a Thermal insulation
3 Furnace bottom
4 Support steelwork
5 Furnace crown
6 Aperture
7 Electrode
7a Thread
7b Conical end
8 Threaded connection
9 Electrode holder
9a Outer tube
9b Inner tube
9c Conical surface
10 Support pillar
11 Swivel joint
12 Swivel lever
13 Joint
14 Jacking mechanism
15 Operator
16 Working platform
17 Swivel radius
18 Elbow
19 Swivel joint
20 Melt surface
21 Metal casing
22 Supply line
23 Supply line
24 Coolant supply
25 Cavity
26 Annular gap
27 Perforated plate
28 Glass melt
29 Gall layer
30 Batch layer
31 Sheath
32 Protective casing
33 Contact cement
34 Front end
35 Cement
36 Ring

1-11. (canceled)

12. An electrode system for glass melting furnaces with an electrode holder installed above a melt surface in a melting tank, with a coolant supply and a metallic electrode that is connected to the electrode holder by means of a coolable threaded connection, whereby the coolant supply extends into an upper end of the electrode, wherein the coolable end of the electrode is surrounded by a sheath made from a ceramic material, and this sheath is at least partially installed in a protective casing made from corrosion and temperature resistant metal.

13. An electrode system according to claim 12, wherein the ceramic sheath is connected to the electrode by a contact cement.

14. An electrode system according to claim 13, wherein the contact cement is made from a material comprising zircon mullites.

15. An electrode system according to claim 13, wherein the contact cement has a thickness from 0.5 to 2 mm.

16. An electrode system according to claim 12, wherein the ceramic sheath is made from a fusion-cast material comprising aluminium-zircon-silicates.

17. An electrode system according to claim 16, wherein the ceramic sheath is a hollow cylinder and has a wall thickness from 10 to 30 mm and a length from 80 to 150 mm.

18. An electrode system according to claim 12, wherein the protective casing is made from a material comprising iron-chromium alloys.

19. An electrode system according to claim 12, wherein the protective casing is made from a stainless steel.

20. An electrode system according to claim 12, wherein the protective casing has a wall thickness from 0.25 to 1.0 mm.

21. An electrode system according to claim 12, wherein the protective casing covers at least an outer circumference area of the ceramic sheath.

22. An electrode system according to claim 21, wherein the protective casing and an upper face of the ceramic sheath are covered with a cement which is connected to the electrode holder.

23. An electrode system for glass melting furnaces, with a metallic electrode threadingly connected to an electrode holder, a coolant supply extending into an end of the electrode, the end of the electrode being surrounded by a sheath made from a ceramic material, and the sheath being at least partially covered by a protective casing made from corrosion and temperature resistant metal.

24. An electrode system according to claim 23, wherein the ceramic sheath is connected to the electrode by a contact cement.

25. An electrode system according to claim 24, wherein the contact cement is made from a material comprising zircon mullites.

26. An electrode system according to claim 24, wherein the contact cement has a thickness from 0.5 to 2 mm.

27. An electrode system according to claim 23, wherein the ceramic sheath is made from a fusion-cast material comprising aluminium-zircon-silicates.

28. An electrode system according to claim 23, wherein the protective casing is made from a material comprising one of iron-chromium alloys and a stainless steel.

29. An electrode system according to claim 23, wherein the protective casing covers at least an outer circumference area of the ceramic sheath.

30. An electrode system according to claim 31, wherein the protective casing and an upper face of the ceramic sheath are covered with a cement which is connected to the electrode holder.

31. A glass melting furnace comprising:
a melting tank for receiving a glass melt with a melt surface,
an electrode holder installed above a position of the melt surface,
a coolant supply,
a metallic electrode connected to the electrode holder by means of a coolable threaded connection, the coolant supply extending into an upper end of the electrode,
a sheath made from a ceramic material surrounding the upper end of the electrode, and
a protective casing made from corrosion and temperature resistant metal at least partially covering the sheath.
